(19) United States
(12) Patent Application Publication
(10) Pub. No.: US 2011/0313947 A1
(43) Pub. Date: Dec. 22, 2011

(54) Financial Practice Management System and Method

(75) Inventor: John Grohovaz, Queensland (AU)

(73) Assignee: MOONSTONE INFORMATION REFINERY INTERNATIONAL PTY LTD, New South Wales (AU)

(21) Appl. No.: 13/129,775

(22) PCT Filed: Nov. 18, 2009
(86) PCT No.: PCT/IB09/55136

§ 371 Date: Sep. 6, 2011

(30) Foreign Application Priority Data
Nov. 18, 2008 (ZA) 2008/09826

(51) Int. Cl. G06Q 40/00

(52) U.S. Cl. 705/36 R

(57) ABSTRACT

There is provided a financial practice management system comprising a database storing client information and cost information; a cost allocation module determines a client servicing value by allocating costs associated with ongoing business activities to the client servicing value and excluding costs associated with new business activities; and an individual client earnings (ICE) ratio module determines a client income value derived from the client's business with the financial advisory business, the ICE ratio module further determines an ICE ratio value for a particular client by dividing the difference between the client income value and the client servicing value with the client income value or the client servicing value, thereby providing a profitability of the particular client. In addition, the invention extends to a method and system to quantify potential new revenue streams which may be generated from products that a client may need during different phases of the client's life.

### BACKGROUND OF THE INVENTION

THIS invention relates to a financial practice management system and method.

Most financial advisory practices provide ongoing services to existing clients. On the one hand, these practices may earn revenue from servicing costs on existing products and on the other hand, the practices may want to increase their revenue by introducing new business products to existing clients or to non-practice clients.

At present, large financial advisory groups make use of various methods to compare categories of clients from a profitability viewpoint. Although these methods provide useful information, the information is mostly too generic to assist in making decisions on targeting specific new clients and/or new product offerings to specific existing clients.

For example, in a head count method the total expenses of a business are divided by the number of clients of the business to obtain a client servicing value or cost. This value is then used in determining a profitability factor.

In another method of determining a client servicing value for profitability (the direct cost allocation method), direct costs in terms of a business offering, product or portfolio are allocated to the relevant clients. The costs not allocated (unallocated or indirect costs) is typically then distributed across all clients by dividing the unallocated expense amount by the client head count. With this method, the client servicing value will be dependent on the client's elected service offering level, as each service level would have different direct costs associated with it. Alternatively, the unallocated expense amount may be allocated across all clients using a ratio that is dependent on the direct and unallocated costs.

One of the shortcomings of the above indicators of profitability is that none of the known methods and systems for assessing profitability of a client or group of clients distinguishes between expenditure on existing services and expenditure on new services. As a result, the profitability indicators are skewed in that new business and service costs are allocated against existing clients who may typically not benefit from such expenditure.

The existing methods and systems also do not provide functionality to quantify potential new revenue streams which may be generated from typical products that a client may need during different phases of the client's life.

The present invention aims to provide a system and method to provide more accurate indications of client profitability as well as to aid advisers of financial companies to interact with clients in a more productive and focused manner thereby to increase revenue.

### SUMMARY OF THE INVENTION

According to a first aspect of the invention there is provided a financial practice management system, comprising
a database storing client information and cost information relating to a financial advisory business;
a cost allocation module configured to determine a client servicing value which is determined by allocating costs associated with ongoing business activities to the client servicing value and excluding costs associated with new business activities; and
an individual client earnings (ICE) ratio module configured to determine a client income value which is income derived from the client's business with the financial advisory business, the ICE ratio module further configured to determine an ICE ratio value for a particular client by dividing the difference between the client income value and the client servicing value with the client income value or the client servicing value, thereby to provide an indication of the profitability of the particular client.

Typically, the cost allocation module is configured to determine the client servicing value of the client by adding the direct cost associated with a service offering of the client and an allocation of indirect ongoing business costs.

Preferably, the cost allocation module obtains the direct cost associated with the service offering of the client from the database.

The cost allocation module, in determining the client servicing value, may determine a total cost for ongoing business activities by adding the value for staff expenses spent on ongoing client business activities and the allocation of a total of staff expenses not related to client activities and other non-staff expenses.

Preferably, the cost allocation module may allocate the total of the staff expenses not related to client activities and other non-staff expenses between ongoing business activities and new business activities based on an ongoing business ratio.

The cost allocation module may be configured to determine the ongoing business ratio by determining staff expenses on client activities, determining staff expenses on ongoing client business activities and dividing the ongoing client business activity staff expenses with the client activity staff expenses.

Additionally, the cost allocation module may calculate the difference between the total costs for ongoing business activities and the total direct cost for service offerings to all clients, the difference being the value of the indirect ongoing business costs.

Typically, the cost allocation module allocates to clients the indirect ongoing business costs based on multiple direct cost ratios, each of the direct cost ratios associated with a particular service level and each direct cost ratio determined by dividing the direct cost for the particular service level with the direct costs for all service levels.

The cost allocation module may determine the values by accessing cost information on the database.

The cost allocation module may be configured to obtain a fixed customised direct cost associated with the client's service level from the database and to add the customised direct cost to the client servicing value thereby to take account of the extra customised cost in the profitability assessment.

The profitable item module may rank groups of clients in accordance with their respective ICE ratio value and allocate the clients with low ICE ratio values to a financial advisor.

According to second aspect of the invention there is provided a method for determining the profitability of a client of a financial advisory business, the method comprising
providing a database storing client information and cost information relating to the financial advisory business;
determining, by a cost allocation module, a client servicing value for a particular client by allocating costs associated with ongoing business activities to the client servicing value and excluding costs associated with new business activities; and
determining, by an individual client earnings (ICE) module, a client income value which is the income derived from the client's business with the financial advisory business from the database and further determining an individual client earnings (ICE) ratio value for the particular client by dividing the difference between the client income value and the client servicing value with the client income value or client servicing value, thereby to provide an indication of the profitability of the particular client.

The client service value of the client is determined by adding the direct cost associated with a service offering of the client and an allocation of indirect ongoing business costs together.

Determining the client servicing value further includes obtaining the direct cost associated with the service offering of the client from the database.

Determining the client servicing value further includes determining a total cost for ongoing business activities by adding the value for staff expenses spent on ongoing client business activities and an allocation of the total of staff expenses which are not related to client activities and other non-staff expenses.

Typically, the allocation of staff expenses not related to client activities and other non-staff expenses between ongoing business activities and new business activities are based on an ongoing business ratio.

The method includes determining the ongoing business ratio by determining staff expenses on client activities, determining staff expenses on ongoing client business activities and then dividing the ongoing client business activity staff expenses with the client activity staff expenses.

Additionally, determining the client servicing value includes calculating the difference between the total costs for ongoing business activities and the total direct cost for service offerings to all clients, the difference being the value of the indirect ongoing business costs.

The indirect ongoing business costs is allocated to clients based on multiple direct cost ratios, each of the direct cost ratios associated with a particular service level and each direct cost ratio determined by dividing the direct cost for the particular service level with the direct costs for all service levels.

Typically, the values are determined by accessing cost information on the database.

The method may further comprise determining the client servicing value by allocating the client servicing value according to a service level of the client.

A fixed cost associated with the client's service level may additionally be obtained from the database and added to the client servicing value thereby to take account of the extra cost in the profitability assessment.

The method may further comprise ranking groups of clients in accordance with their respective ICE ratio value and allocating the clients with low ICE ratio values to a financial advisor.

According to another aspect of the invention there is provided a financial practice management system, comprising
an intelligent database comprising proxy financial information on estimated financial needs of clients associated with a particular income profiles at particular ages;
a financial proxy module configured to obtain a client residential code and a client age for a client, the financial proxy module configured to access the intelligent financial proxy database to obtain a capital asset and/or income profile for the client based on the client residential code and client age, as well as financial need information, thereby to determine potential new financial products for the client based on the financial need information.

The income profiles of clients at particular ages may be based on the estimated household income of a suburb.

The estimated household income per suburb may therefore be associated with an average house price in the suburb and identified by a residential code.

Additionally, the financial proxy module may determine a potential servicing revenue value from the potential new products for the client.

The financial proxy module may further be configured to obtain existing product information relating to products provided to the client by a financial institution from a client database and may determine the potential new financial products by evaluating the financial need information in relation to the existing product information.

The potential servicing revenue value may be commission and/or fees earned on the potential new financial products or ongoing servicing fees on the potential new financial products.

The financial proxy module may further be configured to create a list of financial products for the existing client.

The system may further comprise a profitable item module to rank the list of financial products according to the potential servicing revenue of each product, with the profitable item module allocating the products to a financial advisor of the system.

The financial practice management system may further comprise a data integrity checker module which assigns a value to each data point captured and stored in the database. The value assigned to each data point may be according to the importance of the data point. Alternatively, or in addition, the value assigned to each data point may be according to the age of the data point.

The data integrity checker module monitors each data point according to a set of rules, and lowers the score of the data point once the data point ages according to the set of rules.

The data integrity checker module may generate an alert to be transmitted to a servicing adviser if the value of the data point reaches predetermined low level, thereby allowing the validity of data to be managed.

The financial practice management system may further comprise a psychometric matching module which accesses psychometric evaluation information stored in the data base in order to match clients of a financial service firm with financial advisers of the firm according to predetermined psychometric rules.

According to yet another aspect of the invention there is provided a method for managing a financial practice, the method comprising
providing an intelligent database comprising proxy financial information on estimated financial needs of clients associated with particular income profiles at particular ages;
obtaining a client residential code and a client age for a client;
accessing the intelligent financial proxy database to obtain a capital asset and/or an income profile for the client based on the client residential code and client age, and also to obtain financial need information; and
determining potential new financial products based on the financial need information.

The income profiles of clients at a particular age may be based on the estimated household income of a suburb.

The estimated household income per suburb may therefore be associated with an average house price in the suburb and identified by a residential code.

The method may include determining a potential servicing revenue value from the potential new products for the client.

Preferably, the method further comprises obtaining existing product information relating to products provided to the client by a financial institution from a client database and determining the potential new financial products by evaluating the financial need information in relation to the existing product information.

Additionally, a list of financial products for the existing client may be created.

The method may further comprise ranking the list of financial products according to the potential servicing revenue of each product and allocating the products to a financial advisor.

Preferably, the methods as defined above may comprise assigning a value to each data point captured and stored in the database. The value assigned to each data point may be according to the importance of the data point. Alternatively, or in addition, the value assigned to each data point may be according to the age of the data point.

Each data point may be monitored according to a set of rules, and the score of the data point may be lowered once the data point ages according to the set of rules.

Optionally, the method may comprise generating an alert and transmitting the alert to a servicing adviser if the value of the data point reaches a predetermined low level, thereby allowing the validity of data to be managed.

The methods as defined above may additionally comprise accessing psychometric evaluation information stored in the database in order to match clients of a financial service firm with financial advisers of the firm according to predetermined psychometric rules.

### BRIEF DESCRIPTION OF THE DRAWINGS

FIG. 1 shows a schematic diagram of the implementation of a financial practice management system in accordance with an example embodiment of the present invention;

FIG. 2 shows a block diagram of respective modules of the financial practice management system shown in FIG. 1 in accordance with an example embodiment of the present invention;

FIG. 3 shows a presentation of a graph as an example of the change in need for life cover over a person's life in relation to a build up in the person's investment portfolio and debt;

FIGS. 4 and 5 are graphical representations of web-based interfaces showing a client need analysis and a potential servicing revenue analysis as performed by a financial proxy module of the system in FIG. 1, in accordance with an example embodiment of the present invention;

FIG. 6 is a graphical representation of a web-based interface showing data points having a value assigned by a data integrity checker module of the system in FIG. 1, in accordance with an example embodiment of the present invention;

FIG. 7 shows a simplified flow diagram of a method for determining the profitability of a client of a financial advisory business in accordance with an example embodiment of the present invention;

FIG. 8 shows a simplified flow diagram of a method of determining a client servicing value in accordance with an example embodiment of the present invention, which method forms part of the method shown in FIG. 7; and

FIG. 9 shows a simplified flow diagram of a method for managing a financial practice in accordance with an example embodiment of the present invention.

### DESCRIPTION OF PREFERRED EMBODIMENTS

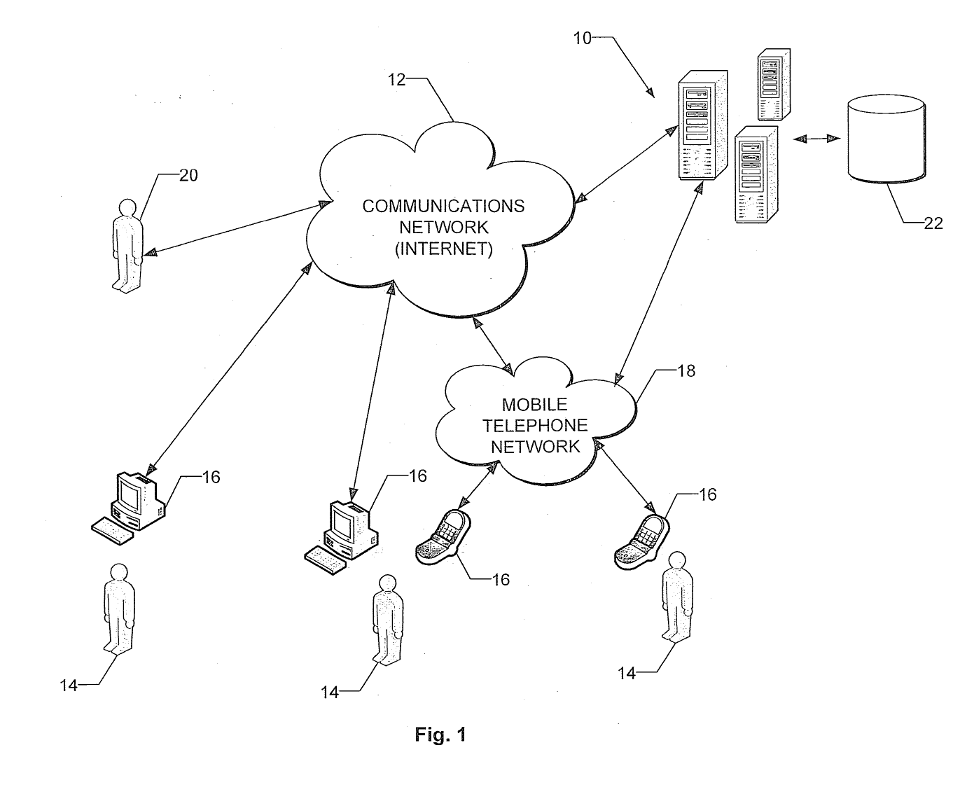

Turning to FIG. 1, a financial practice management system is generally indicated by reference numeral 10. In one preferred embodiment, the system 10 operates as a web-based application hosted on one or multiple servers, the application being accessible through a communication network 12. The financial practice management system 10 is typically employed by financial advisory firms providing financial products and services to clients.

Users, such as financial advisers or brokers, who are typically employees of the financial advisory firms, are indicated by reference numeral 14. These users interact with the system 10 through user terminals 16 in the form of personal computers (PCs) or mobile devices such as mobile or cellular telephones, PDA's (Personal Digital Assistants) or the like. The user terminals 16 are operable to communicate with the system 10 over the communications network 12. In this regard, the communications network 12 may conveniently be the Internet, as shown in FIG. 1, or may be a packet-switched network, a circuit switched network, a public switched data network, or any combination thereof, or the like. Instead, or in addition, the user terminals in the form of mobile or cellular telephones may communicate with the system 10 directly via a mobile telephone network 18, or indirectly through the mobile telephone network and Internet 12. It is to be appreciated that each user may communicate with the system 10 via multiple user devices.

A user 14 typically accesses the system 10 through the user terminals 16 in order to obtain specific client information or to analyse client needs and potential new products to be sold to a new or existing client.

Additionally, the system 10 may also be accessible by clients 20 that could post certain information on the system 10 thereby to obtain a need analysis directly from the system 10 or to allow users 14 to contact them in order to offer specific financial products or services. Similar to the users 14, the clients 20 may also interact with the system through client terminals (not shown) in the form of personal computers (PCs) or mobile devices such as mobile or cellular telephones, PDA's (Personal Digital Assistants) or the like.

The financial practice management system 10 may comprise a plurality of components or modules which correspond to the functional tasks to be performed by the system 10. A “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device. In this regard the modules may reside in the system 10 to provide functionality as described herein.

In one example embodiment, the different modules of the financial practice management system 10 described below may reside in an external central server which would provide various financial advisers from different financial advisory firms, as well as clients, either existing or potential, with access to the system 10. Alternatively, the different modules of the system 10 may reside and be hosted on an internal “private” server, with financial advisers only being able to access the application through a local area network (LAN) or intranet of the particular financial advisory firm.

Apart from the various modules of the system 10, the system further comprises data stores shown as one or more database(s) 22. These databases store client information, product information, cost information including direct and indirect cost related to the business and clients, e.g., direct costs of certain product offerings, financial analysis information. The database(s) 22 may additionally comprise an intelligent database that is created by a financial proxy module described in more detail below. The database(s) 22 may be maintained by the various modules of the financial practice management system 10.

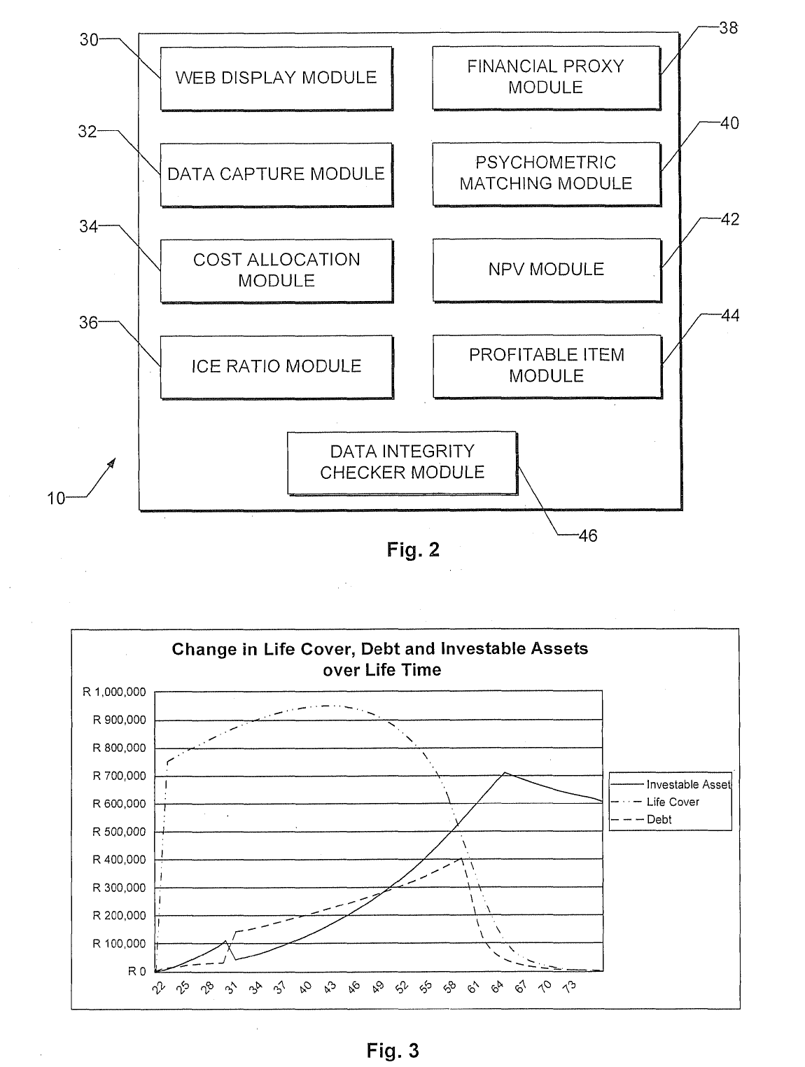

Referring now to FIG. 2, the system 10 may in one example embodiment comprise a web display module 30, a data capture module 32, a cost allocation module 34, an individual client earnings (ICE) ratio module 36, a financial proxy module 38, a psychometric matching module 40, a net present value (NPV) module 42, a profitable item module 44 and a data integrity checker module 46.

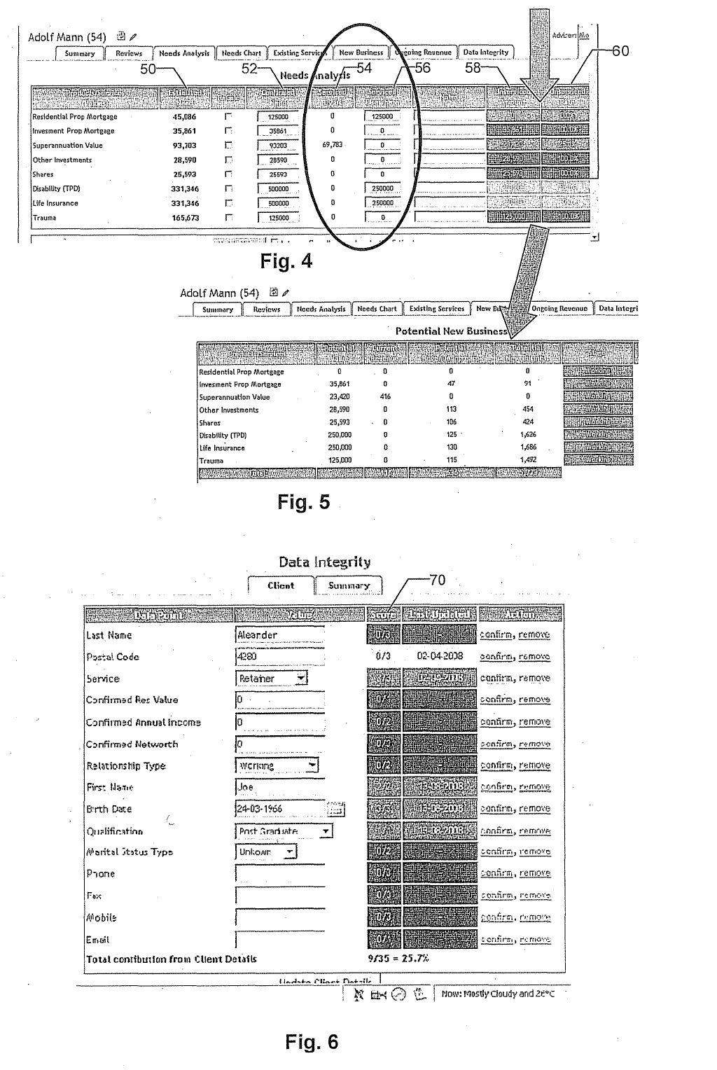

The web display module 30 is configured to provide programmatic and web interfaces to allow users and clients to interact with the financial practice management system 10. For example, the web display module 30 may be hosted on a web server and may interact with the other modules of the financial practice management system 10 in order for the system to display data, capture data, and analyse data. Examples of web-based interfaces provided by the web display module 30 are shown by FIGS. 4 to 6.

The data capture module 32 is configured to receive and store any client data or product data in the relevant data store or database(s) 22. Typically, on signing up a new client, certain information on the client is to be captured by a user 14 of the system 10. This information may either be captured directly onto the system 10 through an appropriate web-based interface provided by the web display module 30 or may first be captured through a paper-based system and then entered into the system 10 at a later stage.

Client information typically captured, recorded and maintained on the database(s) 22 may comprise the following:

General client information: Name of client, date of birth, marital status, smoker or non-smoker, contact details, postal code, information on dependents, financial details, income, etc.
Client product information: product type, investment/cover value, reference number, supplier or product, product anniversary date, etc.
Client income paid to practice information: frequency, amount, source (e.g., product number, direct payment, etc.).
Client service offering: type of service and/or service level, estimated and actual cost (e.g., direct cost on a service) and time of basic and customised servicing activities undertaken by the financial advisory firm, frequency, review date(s), allocated financial adviser.
Client financial needs information: estimated and/or actual financial needs of a client for various products such as mortgage, shares, life, disability and/or risk cover, estate planning, short term insurance, retirement funding, etc.

The general client information listed above is typically recorded when importing a client database or at the time of signing up a new client. The other information may be recorded or calculated as part of an ongoing process, for example, when a client need analysis is being done, when a new product is introduced to the client, when a client profitability study is conducted or on a periodic basis. Records captured by the data capture module 32 are stored, as mentioned above, on the database(s) 22, but may additionally be fed back into other databases (e.g., the intelligent database described below) of the financial advisory firm. In one example embodiment, XML or CSV or similar protocols may be used for the data exchange.

The cost allocation module 34 is configured to calculate the overall costs (expenses) associated with the business of the financial advisory firm. The cost allocation module 34 is particularly enabled to allocate these costs against various clients, whether an individual client or a group of clients, thereby to determine the cost of servicing a particular client, called a client servicing value throughout this document. It is the client servicing value determined by the cost allocation module 34 that enables the ICE ratio module 36 described in more detail below to calculate a profitability indicator in the form of an individual client earnings (ICE) ratio value for each client or a group of clients.

In determining the cost servicing value, the cost allocation module 34 is configured to take various allocations of costs into account. In particular, the cost allocation module 34 takes into account ongoing business costs as opposed to new business costs in order to determine the client servicing value used in the profitability calculations.

Most financial advisory firms and practices provide an ongoing service to existing clients. In addition, practices also look at introducing new business offerings and activities to the existing clients and to non-practice or new clients. It is therefore possible and necessary for the cost allocation module 34 in determining an accurate profitability indicator or ICE ratio to split costs thereby not to allocate costs associated with new business against existing clients. Costs, in particular unallocated or indirect practice costs, are rather split by allocating further expenses in relation to new business activities and ongoing business activities. This is done in accordance with an ongoing business ratio which is determined as an ongoing business cost value over a total cost value, described in more detail below.

In addition, the cost allocation module 34 is also to take into account direct and indirect costs in determining the cost of servicing a particular client. It will be appreciated that direct costs associated with a particular service offering or level could be determined for existing clients and that the ongoing costs allocated against a client would therefore include the direct cost associated with a client service offering. The direct costs and indirect costs relating to the business are therefore determined as part of the cost allocation process in order to determine a breakdown of the ongoing costs to be allocated against existing clients.

Indirect costs typically relate to activities not specifically undertaken for managing a client's portfolio, e.g., rental of premises, cleaning services, advertising, management expenses, and the like.

These indirect costs are typically obtained from estimated costs based on a business unit's budget, actual costs incurred by a business unit, a combination of some or all of the above.

Direct costs relate to activities undertaken specifically for managing a particular client's portfolio, e.g., telephone calls to a client, correspondence, such as letters or e-mails to the client, meetings with the client, and associated costs. For this reason at least some direct costs can be determined on a particular client service offering.

Again, these direct costs are obtained from estimated costs based on a standard service offering to a particular level client, actual costs in servicing the client, estimated customised service offering, and a combination of some or all of the above.

It will be appreciated that the direct costs associated with a particular client service level could be obtained by the cost allocation module from the database 22. When these direct service costs change, the database 22 is typically updated. Alternatively, the direct costs could be entered by employing the web display module 30 and/or the data capture module 32.

In order to split unallocated expenses, i.e., indirect costs, between clients on different service levels, another ratio is used by the cost allocation module 34, namely the direct cost ratio. Different direct cost ratios will apply to different client service levels. This ratio is calculated for each service level as the direct costs associated with the client service level divided by direct costs associated with all service levels.

In order to explain the application of the ratios by the cost allocation module 34 in more detail, we turn to an example of the allocation of costs or expenses as shown in Table 1 below:

TABLE 1

| # | Expense Item | % of total | Amount |
|---|---|---|---|
| 1 | Commission - July | 13.07% | $183,923 |
| 2 | Commission - Monty | 10.59% | $148,923 |
| 3 | Commission - Ralph | 5.42% | $76,196 |
| 4 | Salaries - July | 9.60% | $135,000 |
| 5 | Monty - Salary | 8.88% | $125,000 |
| 6 | Ralph - Salary | 7.82% | $110,000 |
| 7 | Carly - Salary | 4.26% | $59,999 |
| 8 | Lisa - Salary | 4.26% | $60,000 |
| 9 | Ricky - Salary | 6.75% | $95,000 |
| 10 | Matthew - Salary | 6.75% | $95,000 |
| 11 | Catherine - Salary | 3.84% | $54,000 |
| 12 | Dave - Salary | 7.11% | $100,000 |
| 13 | Kerry - Salary | 3.41% | $48,001 |
| 14 | Rent | 2.70% | $38,000 |
| 15 | Management Fees | 0.89% | $12,546 |
| 16 | Interest | 0.48% | $6,759 |
| 17 | Accountancy | 0.32% | $4,500 |
| 18 | Computer Hardware | 0.33% | $4,576 |
| 19 | Subscriptions | 0.17% | $2,354 |
| 20 | Computer Services | 0.16% | $2,234 |
| 21 | Internet | 0.13% | $1,769 |
| 22 | Legal Fees | 0.08% | $1,110 |
| 23 | Motor Vehicle Insurance | 0.07% | $1,052 |
| 24 | Motor Vehicle Registration | 0.04% | $506 |
| 25 | Marketing | 0.16% | $2,306 |
| 26 | Parking | 0.02% | $234 |
| 27 | Bank Charges | 0.01% | $206 |
| 28 | Worker Cover | 0.01% | $121 |
| 29 | Staff Super | 0.20% | $2,778 |
| 30 | Postage | 0.03% | $457 |
| 31 | Stationery | 0.03% | $387 |
| 32 | Office Supplies | 0.11% | $1,586 |
| 33 | Motor Vehicle Petrol | 0.15% | $2,042 |
| 34 | Interstate Travel | 0.31% | $4,500 |
| 35 | Motor Vehicle Services | 0.09% | $1,253 |
| 36 | Seminars | 0.17% | $2,432 |
| 37 | Accommodation | 0.06% | $825 |
| 38 | Meals | 0.05% | $637 |
| 39 | Cabcharge | 0.01% | $174 |
| 40 | Education | 0.01% | $132 |
| 41 | Telephone | 0.62% | $8,751 |
| 42 | Sub Agency Com | 0.83% | $11,620 |
| | Total Expenses | 100% | $1,406,883 |

Once all the practice expenses have been listed, these can then be allocated to the different clients by the cost allocation module 34 in terms of the ratios mentioned above.

From Table 1 it is evident that the total practice expenses for this particular example financial advisory firm amounts to $1,406,883. By way of example, this financial advisory firm has 595 clients and different service levels are available to these clients.

In this example, 150 of the 595 clients are on a “high” service package (i.e., the client's service level). It is known and/or can be determined by the cost allocation module 34 that the “high” service package incurs direct service costs of $2,000 per package per year. The remainder of the clients (445) are on a “normal” service package that has direct service costs of $1,000 per package per year associated with it. For example, “high” service package clients may contractually have quarterly visits to their offices, may be issued with more reports and advisories or the like which would increase their direct costs.

Taking the above into account, it is quite simple to determine the total direct cost per service level. This breakdown in costs is shown in Table 2 below.

TABLE 2

| | No. of | Direct Cost per | Direct Cost per |
|---|---|---|---|
| Service Level | Clients | Client | Service Level |
| High | 150 | $2,000.00 | $300,000 |
| | | | (150 × $2,000) |
| Normal | 445 | $1,000.00 | $445,000 |
| | | | (445 × $1,000) |
| Total | 595 | $3,000.00 | $745,000 |

The unallocated expenses or indirect costs would be the difference between the total costs/expenses of the financial advisory firm and the total direct cost, i.e. $745,000. The unallocated expenses are therefore determined as follows:

Unallocated Expenses=Total Expenses−Total Direct Service Costs=$1,406,883−$745,000=$661,883 (Equation 1)

In addition to the above calculations, the cost allocation module 34 also determines an ongoing business ratio. In this regard we turn to Table 3 which shows a breakdown of ongoing business costs in staff expenses, thereby to better explain this process.

TABLE 3

| | | | | | | Of Client | Cost of |
|---|---|---|---|---|---|---|---|
| | | | | Staff Time on | | Activities, | Ongoing |
| | | | | Client Related | Cost of Client | Time Spent on | Business |
| Expense | | Amount | Headcount | Activities | Activities | Ongoing Business | Client Activities |
| Category | Expense Item | ($) | Total | (%) | ($) | (%) | ($) |
| Staff Expenses - | Commission - | 183,923 | | 100 | 183,923 | 0 | — |
| Commission | Julie | | | | | | |
| Staff Expenses - | Commission - | 148,923 | | 100 | 148,923 | 0 | — |
| Commission | Monty | | | | | | |
| Staff Expenses - | Commission - | 76,196 | | 100 | 76,196 | 0 | — |
| Commission | Ralph | | | | | | |
| Staff Salaries | Salaries - Julie | 135,000 | | 90 | 121,500 | 80 | 97,200 |
| Staff Salaries | Ricky | 95,000 | | 100 | 95,000 | 100 | 95,000 |
| Staff Salaries | Matthew | 95,000 | | 100 | 95,000 | 100 | 95,000 |
| Staff Salaries | Monty | 125,000 | | 90 | 112,500 | 80 | 90,000 |
| Staff Salaries | Ralph | 110,000 | | 90 | 99,000 | 80 | 79,200 |
| Staff Salaries | Lisa | 60,000 | | 100 | 60,000 | 80 | 48,000 |
| Staff Salaries | Carly | 59,999 | | 100 | 59,999 | 80 | 47,999 |
| Staff Salaries | Catherine | 54,000 | | 50 | 50,000 | 75 | 37,500 |
| Staff Salaries | Dave | 100,000 | | 100 | 54,000 | 60 | 32,400 |
| Staff Salaries | Kerry | 48,001 | | 50 | 24,001 | 75 | 18,000 |
| Rent | Rent | 38,000 | 38,000 | n/a | n/a | n/a | n/a |
| Consulting Fees | Management | 12,546 | 12,546 | n/a | n/a | n/a | n/a |
| | Fees | | | | | | |
| Consulting Fees | Interest | 6,759 | 6,759 | n/a | n/a | n/a | n/a |
| Consulting Fees | Accountancy | 4,500 | 4,500 | n/a | n/a | n/a | n/a |
| Computer | Computer | 4,576 | 4,576 | n/a | n/a | n/a | n/a |
| | Hardware | | | | | | |
| General | Subscriptions | 2,354 | | n/a | n/a | n/a | n/a |
| Compute | Computer | 2,234 | 2,234 | n/a | n/a | n/a | n/a |
| | Services | | | | | | |
| Compute | Internet | 1,769 | 1,769 | n/a | n/a | n/a | n/a |
| Consulting Fees | Legal Fees | 1,110 | | n/a | n/a | n/a | n/a |
| Motor Vehicle | Motor Vehicle | 1,052 | | n/a | n/a | n/a | n/a |
| | Insurance | | | | | | |
| Motor Vehicle | Motor Vehicle | 506 | 506 | n/a | n/a | n/a | n/a |
| | Registration | | | | | | |
| Marketing | Marketing | 2,306 | 2,306 | n/a | n/a | n/a | n/a |
| General | Parking | 235 | 235 | n/a | n/a | n/a | n/a |
| General | Bank Charges | 206 | 206 | n/a | n/a | n/a | n/a |
| Staff Expenses - | Worker Cover | 121 | 121 | n/a | n/a | n/a | n/a |
| Other | | | | | | | |
| Staff Expenses - | Staff Super | 2,778 | | n/a | n/a | n/a | n/a |
| Other | | | | | | | |
| General | Postage | 457 | | n/a | n/a | n/a | n/a |
| General | Stationery | 387 | | n/a | n/a | n/a | n/a |
| General | Office Supplies | 1,586 | 1,586 | n/a | n/a | n/a | n/a |
| Motor Vehicle | Motor Vehicle | 2,042 | | n/a | n/a | n/a | n/a |
| | Petrol | | | | | | |
| Travel | Interstate Travel | 4,500 | | n/a | n/a | n/a | n/a |
| Motor Vehicle | Motor Vehicle | 1,253 | | n/a | n/a | n/a | n/a |
| | Services | | | | | | |
| General | Seminars | 2,432 | | n/a | n/a | n/a | n/a |
| General | Accommodation | 825 | | n/a | n/a | n/a | n/a |
| General | Meals | 637 | | n/a | n/a | n/a | n/a |
| General | Cabcharge | 174 | | n/a | n/a | n/a | n/a |
| General | Education | 132 | | n/a | n/a | n/a | n/a |
| General | Telephone | 8,751 | | n/a | n/a | n/a | n/a |
| Marketing | Sub Agency | 11,620 | | n/a | n/a | n/a | n/a |
| | Com | | | | | | |
| | Total Expenses | 1,406,882 | 75,338 | | | | |
| | | | | | 1,180,041 | | 640,300 |

As can be seen from the first couple of lines of Table 3, staff expenses relating to commission and salaries are easily apportioned according to time/cost spent on client related activities in general (Column: Staff Time on Client Related Activities (%) and Column: Cost of Client Activities ($)) and then further according to the percentage of time spent on ongoing business client activities (Column: Of Client Activities, Time Spent on Ongoing Business (%) and Column: Cost of Ongoing Business Client Activities ($)). It will be appreciated that not all time spent by a staff member would be on client activities, as at least some staff would have various administrative tasks unrelated to any client activity.

In this example, the resultant amount of $1,180,041 shows cost related to staff commission and salaries spent on client activities only, while the resultant amount of $640,300 in the final column of Table 3 shows the staff expenses (normally the largest cost of a practice) allocated to ongoing business activities, directed at existing clients. The ongoing business ratio, indicative of the proportion of time staff spends on ongoing business offerings and activities, is therefore calculated as follows in a preferred example embodiment:

$$\begin{matrix}Ongoing Business Ratio = \frac{\begin{matrix}Staff Expenses \text{:} Ongoing \\ Business Client Activities\end{matrix}}{\begin{matrix}Staff Expenses \text{:} \\ Total Client Activities\end{matrix}} \\ = \frac{\$640 \text{,} 300}{\$1 \text{,} 180 \text{,} 041} \\ = 54.26 \%\end{matrix} \qquad ( Equation 2 )$$

The ongoing business ratio is then used to allocate the non-client staff expenses (such as administrative time) and other expenses (such as overheads) between ongoing business activities and new business activities. It will be appreciated that this allocation can either be effected by a simple subtraction or by calculating a new business ratio where the new business ratio is equal to 100% minus the ongoing business ratio. The next equation shows the calculation of the total of the non-client staff expenses and other expenses, while Tables 4 and 5 deal with the allocation of costs with relation to ongoing and new business activities.

$$\begin{matrix}\begin{matrix}NonClient Staff \\ Expenses and \\ Other Expenses\end{matrix} = Total Expenses - Client \\ Related Staff Expenses \\ = \$1 \text{,} 406 \text{,} 882 - \$1 \text{,} 180 \text{,} 041 \\ = \$226 \text{,} 841\end{matrix} \qquad ( Equation 3 )$$

TABLE 4
Ratios
(for Allocation of NonClient Staff Expenses and
Other Expenses)

| | |
|---|---|
| Ongoing Business Ratio | 54.26% |
| New Business Ratio | 45.74% |
| | (100%-54.26%) |

TABLE 5

| COST OF ONGOING | | COST OF NEW BUSINESS | |
|---|---|---|---|
| BUSINESS ACTIVITIES | | ACTIVITIES | |
| Staff | $640,300 | Staff | $539,741 |
| Related | | Related | ($1,108,041-$640,300) |
| Other | $123,086 | Other | $103,756 |
| Costs | ($226,841 × 54.26%) | Costs | ($226,841-$123,086) or |
| | | | ($226,841 × 45.75%) |
| | $763,386 | | $643,497 |
| | | $1,406,882 | |

In accordance with the calculations shown above, it was determined that direct costs of $745,000 are associated with the different service packages (“high” and “normal”). As mentioned, this direct cost forms part of the ongoing business cost as it is associated with existing products and services. The difference between the total cost of ongoing business activities and the total direct cost of all service packages are then to be determined by the cost allocation module 34 and allocated to clients.

As shown in Table 6, the balance between these values, which are the indirect or unallocated ongoing business costs, is $18,386 for the present example.

TABLE 6

| | |
|---|---|
| Total Costs of Ongoing Business Activities | $763,386 |
| minus Direct Cost of Service Packages | $745,000 |
| minus Headcount Costs | $— |
| =Balance to Indirect Ongoing Business Costs | $18,386 |

The headcount costs mentioned in Table 6 relates to customised costs of a particular client. For example, a client on a high service package may insist that a financial adviser visit the client at home, rather than consulting at the adviser's office. This request may entail travelling time of 90 minutes to and from the client's home, which would result in additional costs of, for example $175. Such an amount usually has to be deducted to determine the indirect ongoing business costs.

In terms of the invention, this amount is allocated or apportioned to a client on a particular service level by employing the direct cost ratio for a particular service level. See the following equation:

$$Direct Cost {Ratio}_{Service Level X} = \frac{Direct {Costs}_{Service Level X}}{\begin{matrix}Direct Costs for all \\ Service Levels\end{matrix}} \qquad ( Equation 4 )$$

Table 7 indicates the application of the equation in order to determine a direct cost ratio of 40.27% for the “high” service level, while a direct cost ratio of 59.73% is determined for the “normal” service level.

TABLE 7

| Service | No. of | | | Direct Cost |
|---|---|---|---|---|
| Level | Clients | Direct Cost | Total | Ratio (%) |
| High | 150 | $2,000.00 | $300,000 | 40.27% |
| Normal | 445 | $1,000.00 | $445,000 | 59.73% |
| Total | 595 | $3,000.00 | $745,000 | |

These respective ratios are multiplied with the indirect/unallocated ongoing business cost value and then divided by the number of clients receiving the particular service level, resulting in the values shown in Table 8:

TABLE 8

| | | Allocation of | |
|---|---|---|---|
| | | Indirect Ongoing | Total Service |
| | Direct Costs | Business Costs | Value/Cost |
| Service Level | per Client | per Client | per Client |
| High | $2,000 | $49 $\frac{( \$18 , 386 \times 40.27 \% )}{150}$ | $2,049 |
| Normal | $1,000 | $25 $\frac{( \$18 , 386 \times 59.73 \% )}{445}$ | $1,025 |

It will be appreciated that this total service cost value also called the client servicing value which is apportioned to a particular client is reflective of the real cost incurred with relation to a particular client as it is stripped from new business expenses and costs.

Similar to the way in which ongoing costs are allocated accurately to ongoing business servicing activities, so are the new business costs allocated to new business services and activities. After the direct costs of performing a new business service (e.g., the basic investment, complex investment, risk basic etc. as set out below) or activity (e.g. referral source appt, new calls etc. as below) are determined or obtained by the system (in particular the cost allocation module 34) by taking time and materials into account, the allocation of indirect costs takes place to ensure the more accurate costing of new business activities. As per the example above, the new business costs/expenses of $643,497 (calculated in Table 5) would be allocated in a similar fashion, as shown in Tables 9 and 10.

TABLE 9

| | | Direct | Total | | | | Per | | | Total New |
|---|---|---|---|---|---|---|---|---|---|---|
| | No. of New | Costs per | Direct | | Unallocated | Total | Client | | Retail | Business |
| New Business | Business | Package | Costs | | Costs | Cost | Cost | ICE | Fee | Revenue |
| Services | Services | ($) | ($) | % | ($) | ($) | ($) | (%) | ($) | ($) |
| Basic | 200 | 895 | 179,000 | 28.26 | 2,825 | 181,825 | 909 | 55 | 2,020 | 404,055 |
| Investment | | | | | | | | | | |
| Mid Tier | 50 | 1,250 | 62,500 | 9.87 | 986 | 63,486 | 1,270 | 50 | 2,539 | 126,973 |
| Investment | | | | | | | | | | |
| Complex | 25 | 2,545 | 63,625 | 10.04 | 1,004 | 64,629 | 2,585 | 50 | 5,170 | 129,258 |
| Investment | | | | | | | | | | |
| Risk Basic | 100 | 695 | 69,500 | 10.97 | 1,097 | 70,597 | 706 | 65 | 2,017 | 201,705 |
| Risk Mid Tier | 50 | 1,255 | 62,750 | 9.91 | 990 | 63,740 | 1,275 | 55 | 2,833 | 141,645 |
| Risk Complex | 25 | 2,750 | 68,750 | 10.85 | 1,085 | 69,835 | 2,793 | 50 | 5,587 | 139,670 |
| Corporate | 10 | 3,750 | 37,500 | 5.92 | 592 | 38,092 | 3,809 | 50 | 7,618 | 76,184 |
| Fund | | | | | | | | | | |

| | | | | | |
|---|---|---|---|---|---|
| 460 | 543,625 | 85.81 | 8,579 | 552,204 | 1,219,489 |

TABLE 10

| | | Direct | | | | |
|---|---|---|---|---|---|---|
| | No. of New | Costs per | Total | | Unallocated | Total |
| New Business | Business | package | Direct | | Costs | Cost |
| Services | Services | ($) | ($) | % | ($) | ($) |
| New calls | 1750 | 8.50 | 14,875 | 2.35 | 235 | 15,110 |
| 1^{st} | 450 | 145.00 | 65,250 | 10.30 | 1,030 | 66,280 |
| Appointments | | | | | | |
| Referral | 50 | 195.00 | 9,750 | 1.54 | 154 | 9,904 |
| source appt | | | | | | |
| | | | 89,875 | 14.19 | 1,418 | 91,293 |
| | | | 633,500 | 100 | 9,997 | 643,497 |

Similar to the direct cost ratio equation shown above, the new business direct cost ratio is to be determined by using the following equation, which is similar to the direct cost ratio equation:

$$New Business Direct Cost {Ratio}_{Service i} = \frac{New Business Direct {Costs}_{Service i}}{Direct Costs for all New Business Services} \qquad ( Equation 5 )$$

For example, and referring to the first line of Table 9, the new business direct cost ration for a basic investment is determined as follows:

$$New Business Direct Cost {Ratio}_{Basic Investment} = \frac{\$179 \text{,} 000}{\$633 \text{,} 500} = 28.25 \% \qquad ( Equation 6 )$$

The total unallocated expenses value is determined by subtracting the total direct costs for all new business activities from the total new business activity costs, as shown directly below:

$$Total Unallocated Costs = Total New Business Costs - Total Direct Costs for New Business Activities \\ i . e . , \$643 \text{,} 497 - \$633 \text{,} 500 = \$9 \text{,} 997 \qquad ( Equation 7 )$$

It follows that the unallocated cost value for each new business activity is then calculated by multiplying the total unallocated cost value with the particular new business direct cost ratio.

This method provides value to the financial services firm as it allows for the accurate costing of what retail fee to charge for a particular new business service as well as to derive a new business budget.

When a client servicing value has been determined by the cost allocation module 34 as set out above, the ICE ratio module 36 of the financial practice management system uses the earnings or client income value of a particular client to determine a measure of the profitability (an ICE ratio) of the client for a particular service package as a percentage. The income from the client is the income derived by the financial advisory firm from the client's business.

One formula to calculate the ratio is:

$$ICE ratio = \frac{( Income from Client ) - ( Client Servicing Value )}{Income from Client} \cdot 100 \qquad ( Equation 8 )$$

For example, if the income derived from the client's business is $200 and the client servicing value (i.e., the cost (expenses) relating to servicing the client as determined above) is $125, the ICE ratio is calculated as follows:

$$ICE ratio = \frac{( \$ 200 - \$125 )}{\$200} = \frac{\$75}{\$200} = 37.5 \%$$

An alternative equation that may be used to calculate a cost ICE ratio is the following:

$$ICE ratio = \frac{( Income from Client ) - ( Client Servicing Value )}{Client Servicing Value} \cdot 100 \qquad ( Equation 9 )$$

For example, with an income of $200 and a client servicing value of $125, the ICE ratio according to this equation will be:

$$ICE ratio = \frac{( \$200 - \$125 )}{\$125} = \frac{\$75}{\$125} = 60 \%$$

By obtaining a ratio for various clients, it is possible to compare directly small and large revenue clients and to view individual clients as isolated profit centers with individual earnings thereby allowing each client to be managed accordingly. The financial practice management system 10, and in particular the profitable item module 44, may rank the clients according to the individual earnings ratio values and allocate the most “problematic” clients, i.e., clients with a very low ICE ratio value, to a financial adviser.

On a practical level, by determining an ICE ratio value for all clients, an effective comparison may be made between for instance; high net worth clients with large portfolios and heavy servicing requirements and clients with smaller portfolios and low servicing requirements. If the high net worth client paying fees of $25,000 annually with client servicing values of $15,000 is evaluated in the conventional manner, the profit would be $10,000. For the client with a smaller portfolio with fees of $250 and servicing costs of $125 to be evaluated in the same manner will result in profit of $125. However, when the ICE ratio is applied the result is 40% (($25,000−$10,000)/$25,000)) for the high net worth client but 50% for the client with the smaller portfolio ($250−$125)/$250. From a groups earnings perspective it would therefore be better to allocate corporate resources to clients with smaller portfolios as the business would be making 50% on revenue versus 40% servicing the high net worth clients.

Typically, the measurement period for the ICE ratio is a financial year and is for recurring income items. However, the ICE ratio may also be used to calculate earnings for a client since the client joined the firm, may be for recurring and non-recurring income (e.g., once off commissions, payments etc.) or a combination of both; and may be used to project future earnings.

From the description of the calculations of the cost allocation module 34, it follows that the more accurate the allocation of costs of the business to respective clients, the more valuable and informative the ICE ratio value for a particular client would be.

The prior art methods of determining client servicing costs are now briefly reviewed to obtain a comparison in the ICE ratio values. Thus, where a client has an income of $2,500 and the head count method is applied for allocation of costs, the client servicing value is determined as:

$$\begin{matrix}Client Servicing Value = \frac{Total Expenses}{No . of Clients} \\ = \frac{\$1 \text{,} 406 \text{,} 883}{595} \\ = \$2 \text{,} 365 per client\end{matrix} \qquad ( Equation 10 )$$

In this scenario, the ICE ratio value for the client would be:

$$ICE ratio = \frac{( \$2 \text{,} 500 - \$2 \text{,} 365 )}{\$2 \text{,} 500} = \frac{\$135}{\$2 \text{,} 500} = 5.4 \%$$

With the second allocation of cost method, (the direct cost allocation method), direct and indirect costs are allocated to particular clients. With this method, the client servicing value will be dependent on the client's elected service level.

For example, similar to Table 1 above, the total direct cost for the “high” service package is $300,000 (150 clients) while the total direct cost for the “normal” service package (445 clients) is $445,000.

The unallocated expenses, after having considered the direct service costs, would in this example again be calculated as follows:

Unallocated Expenses=Total Expenses−Direct Service Costs=$1,406,883−$745,000=$661,883 (Equation 1)

The unallocated expenses of $661,883 are then allocated to clients by using the headcount method of above. Example calculations are shown by the following equation and in Table 11.

$$\frac{Unallocated Expenses}{No . of clients} = \frac{\$661 \text{,} 883}{595} = \$1 \text{,} 242 \qquad ( Equation 11 )$$

TABLE 11

| | | | Total Service |
|---|---|---|---|
| | Direct Cost per | Indirect Cost | Cost/Value per |
| Service Level | Client | per Client | Client |
| High | $2,000 | $1,242 | $3,242 |
| Normal | $1,000 | $1,242 | $2,242 |

For the high service package costs at $3,242 and normal service package costs at $2,242, the ICE ratio values would be as follow:

$$\begin{matrix}ICE {ratio}_{high service level} = \frac{( \$2 \text{,} 500 - \$3 \text{,} 242 )}{\$2 \text{,} 500} \\ = \frac{- \$724}{\$2 \text{,} 500} \\ = - 28.9 \%\end{matrix}$$

$$\begin{matrix}ICE {ratio}_{normal service level} = \frac{( \$2 \text{,} 500 - \$2 \text{,} 242 )}{\$2 \text{,} 500} \\ = \frac{\$258}{\$2 \text{,} 500} \\ = 10.3 \%\end{matrix}$$

Similarly, for the direct allocation of expenses method, where the high service package has allocated costs of $3,777 and the normal service package has costs at $1,888, determined with the direct cost ratio, the ICE ratios would be as follows:

$$\begin{matrix}ICE {ratio}_{high service level} = \frac{( \$2 \text{,} 500 - \$3 \text{,} 777 )}{\$2 \text{,} 500} \\ = \frac{- \$1277}{\$2500} \\ = - 51.1 \%\end{matrix}$$

$$\begin{matrix}ICE {ratio}_{normal service level} = \frac{( \$2 \text{,} 500 - \$1 \text{,} 888 )}{\$2 \text{,} 500} \\ = \frac{\$612}{\$2 \text{,} 500} \\ = 24.5 \%\end{matrix}$$

It will be appreciated that the negative ICE ratios of the high package clients and the higher profitability of the normal service package clients are not necessarily representative of the true state of the business. It is for this reason that the present invention provides a more effective way of allocating cost by splitting the cost between ongoing business activities and new/future business activities.

In employing the present invention, and as shown above, the client servicing value for the high service package is determined as $2,049 and the client servicing value for the normal service package as $1,025. In using these client servicing values, the respective ICE ratios in accordance with the present invention are as follows:

$$\begin{matrix}ICE {ratio}_{high service level} = \frac{( \$2500 - \$2049 )}{\$2500} \\ = \frac{\$451}{\$2500} \\ = 18 \%\end{matrix}$$

$$\begin{matrix}ICE {ratio}_{normal service level} = \frac{( \$2500 - \$1025 )}{\$2500} \\ = \frac{\$1475}{\$2500} \\ = 59 \%\end{matrix}$$

From the ICE ratios calculated above, it is clear that the normal service level is far more profitable than the high service level. A similar principal applies when calculating actual ICE returns based on expenditure incurred.

It would further be appreciated that the cost allocation module 34 may additionally add customised costs to a particular client's client servicing cost value, when appropriate. For example, a client on a high service package may insist that a financial adviser visit the client at home, rather than consulting at the adviser's office. This request may entail travelling time of 90 minutes to and from the client's home, which would result in additional costs of, for example $175, which amount should be added to the client servicing value. In adding this value to the client servicing value, the ICE ratio value for this particular client will decrease as follows:

$$\begin{matrix}ICE {ratio}_{high level service} = \frac{( \$2500 - ( \$2 \text{,} 049 + \$175 ) )}{\$2 \text{,} 500} \\ = \frac{\$276}{\$2 \text{,} 500} \\ = 11 \%\end{matrix}$$

The value added to the equation above, i.e. the $175 is the amount that would have been deducted in Table 6.

The advantage of the above method is that in arriving at a more accurate cost allocation a more precise reflection of the true earnings/profitability of each client is provided. The typical head count cost allocation approach results in low revenue clients (the majority of clients) being allocated a higher proportion of fixed costs thus potentially showing up as not so profitable (e.g., 5.4% above). Similarly, by including new business activity costs, costs incurred by the new business area of the business are being subsidized by the ongoing activity area (e.g., ICE ratio of −51% on the high service package and +24% on the normal service package). By stripping out new business activity costs when allocating ongoing expenses (and vice versa), a more precise trend emerges (i.e., an ICE ratio of +18% on the high service package and a +59% ratio on the normal service package).

The web display module 30 of the system 10 allows this information to be presented to a user in order to provide information on the type of client that should be targeted for future work.

Turning now to the financial proxy module 38 shown in FIG. 2, this module is configured to determine the typical products a client should have and is further configured to estimate the potential servicing revenue value that could be derived from new products sold to an existing client. For example, the potential products that could be sold to an existing client may be calculated by the equation:

$$Potential products = ( Products client should have ) - ( Prod uc ts already serviced for the client ) \qquad ( Equation 12 )$$

A financial advisory firm would usually have the necessary information on the portfolio of products of an existing client. Once the potential products have been determined by the financial proxy module 38, it would be a simple exercise to estimate the commission and/or fees and ongoing fees that make up the potential servicing revenue value to be earned from the potential products.

In order to determine the potential products, the financial proxy module 38 references an intelligent financial proxy database of financial needs of clients at different ages and income/wealth levels. Depending on the age and income level of the client, different expected product profiles are generated by the financial proxy module 38.

For example, a married person in their forties with children would normally need personal risk cover (such as life, disability, income replacement, or the like) to replace future income streams for dependants (e.g., children) should a risk event occur. On the other hand, a retired person in their eighties would not usually need personal risk cover as their investment and retirement funding would provide their sustainable income and children should no longer be dependants.

Besides needing different financial products at different ages, a forty year old who is a partner in an accounting firm would typically need different levels of products compared to a farm laborer of the same age, as the expected income requirements of these parties would be different (e.g., more risk cover, higher expected retirement fund, higher expected mortgage requirements etc.).

Turning to FIG. 3, a graph is shown as a further example on the change in need for life cover over a person's life in relation to a build up in the person's investment portfolio and debt. Risk insurance, such as life cover and disability cover, are typically to provide capital or income to replace income-earning potential that has been lost.

The first step of the financial proxy module 38 in the creation of the intelligent financial proxy database is the establishment of a products table that is representative of an average client in terms of types of products and the value of the products over the lifetime of the products. This is achieved through either extrapolating from available statistics, marketing intelligence or actual data. As and when actual data values for clients are recorded in the system 10, the intelligent database updates itself accordingly to provide increasingly more accurate financial proxy estimates using the actual data.

For example, an estimated household income per suburb may be determined from data relating to people living in a particular area. This information may, in one example embodiment, be associated with a residential code (e.g., the postal code for the area) and the average house price in the area. It will be appreciated that, as more actual data on people living in a particular area becomes available, the estimated household income for that suburb would become more accurate as the database will be updated.

In order to determine an estimated gross household annual income for a person in a particular suburb, the estimated household income per suburb is multiplied by a factor reflective of the household income as a percentage. For example, if the estimated household income for a suburb is R67 571, this amount is multiplied by the factors as shown below for the respective age of the person:

TABLE 12

| AGE | % |
|---|---|
| 22 | 52% |
| 24 | 66% |
| 26 | 71% |
| 28 | 75% |
| 30 | 80% |
| 32 | 84% |
| 34 | 91% |
| 36 | 100% |
| 38 | 109% |
| 40 | 118% |
| 42 | 127% |
| 44 | 136% |
| 46 | 145% |
| 48 | 158% |
| 50 | 176% |
| 52 | 194% |
| 54 | 211% |
| 56 | 229% |
| 58 | 247% |
| 60 | 129% |
| 62 | 123% |
| 64 | 118% |
| 66 | 115% |
| 68 | 106% |

It is to be noted that the factor/percentage increases up to a retirement age, where after it starts to decrease. It will be appreciated that variations on financial proxy models may use demographic trends that show financial wealth, e.g., income, peaking at difference ages.

From the estimated gross household annual income, the financial proxy module 38 determines a capital asset and/or an income profile for each client. In one example embodiment, values may be determined for the following, at each age of the client:
Investable Assets: retirement funds and investment funds
Lifestyle Assets: residence, motor vehicles, household contents
Debt: mortgages, vehicles, household contents
Gross Assets
Net Assets
Executorship Value

The above values may be determined by making certain assumptions on clients, e.g., by basing the financial proxy on a person with particular characteristics such as:

### Age 22 to 29:

The person does not own property, buys household content mainly on credit, acquires a motor vehicle mainly on credit, is saving to put down a deposit on a property, puts away 7.5% of annual income in retirement funds over working life to 65.

### Age 30 to 49:

The person buys property and by the age of 40 no more credit is required for household items.

### Age 50 to 64:

The person starts increasing bond repayments and pays off the last motor vehicle at retirement date.

### Age 65 and Beyond:

The person retires debt free on 60% of final salary. 6% of investable assets are drawn in retirement to live on.

It will be appreciated that as more real data points become available the proxies for people's ages and for the area could be readjusted.

Based on the quantum of the risk products in the table (e.g. level of life cover) the next step in the process is to derive the expected premium at each age. This is achieved by referring to appropriate risk tables. Based on the premiums, it is possible to calculate estimated commissions/fees or servicing fees for each client. For investment or debt products, average service fees can be applied to calculate expected fees from the investable assets needed.

Assume, based on a financial proxy table, Client A, age 45, with an annual income of $100,000 is estimated to need $1,200,000 life cover. Assume Client A is a client with XYZ practice and has a policy for $500,000 life cover that is serviced by the practice. The financial proxy module 38 would estimate that $1,200,000−$500,000=$700,000 of life cover which is the projected shortfall for Client A.

The process involved here is essentially:

Estimated Proxy value for a product−actual value serviced=potential shortfall.

The financial proxy module 38 would also calculate the estimated commission/fees and ongoing servicing fees that could be earned for selling Client A a life policy of $700,000.

For example and as shown in the more detailed example embodiment for a particular client, the client's estimated needs may be determined through the financial proxy module as shown by column 50 in FIG. 4. As mentioned, the financial proxy module 38 estimates not only the household income, but based on the person's age, the typical types of products and the potential value of all the financial products that household would typically have as well as the associated ongoing fees that could be earned and the commission potential for introducing the new products.

Once a financial broker, an employee of the financial advisory firm or an automated system has communicated with the client, the financial needs may be confirmed and this data may be captured by the data capture module 32 through a web-based interface as shown in FIG. 4. Once captured, the data may be reflected as shown by column 52 in FIG. 4. According to the financial advisory firm's records, it could be determined which amounts are serviced by the financial advisory firm (column 54), while data can further be captured in the event of servicing elsewhere (column 56). The financial proxy module 38 would then determine the unserviced amounts (shown by column 58) and may display it to the financial adviser. Each unserviced amount will have a potential servicing rate and/or value associated with it (shown by column 60).

Based on these unserviced amounts, the estimated potential servicing income based on industry standards that could be earned is then shown in a new business web-based interface shown in FIG. 5. In the case of this client, Adolf Mann, it is estimated by the financial proxy module 38 that upfront commissions would amount to $5,733 and annual ongoing revenue would amount to $636.

It follows from the above that, based on the information in the intelligent database, a client's age and residence code (postal code) the financial proxy module 38 determines the value of potential servicing revenue in the form of commission/fees and ongoing fees that can be earned off each client in a database for a variety of financial products.

Using the information obtained above and taking into account existing services the client has with the financial institution, a list of services that the client is not being serviced on is generated. The profitable item module 42 allows ranking in terms of the potential servicing revenue of each product, i.e. highest potential commission from these non serviced products or other criteria. These leads or products may be allocated to the financial adviser.

As mentioned, the system 10 may further comprise a psychometric matching module 40. This module accesses information stored in the database 22 in order to match clients with advisers based on their individual personality profiles. For example, the data capture module 32 may capture psychometric evaluation information for an adviser and client on the completion of respective psychometric evaluation. This evaluation may be an online, web-based evaluation or may be a form filled in by the adviser or client and the data then captured at a later stage. The data capture module 32 stores the psychometric evaluation information in the database 22. The psychometric matching module 40 may then match clients with advisers based on predetermined psychometric rules, e.g., in order to match “like-with-like” personalities, to match a more receptive and patient adviser with a negative client or to match a more gentle adviser with an older sensitive client.

The net present value (NPV) module 42 is configured to determine the Net Present Value (i.e. capital value) of each client in a practice using their specific net earnings and the client's life expectancy as a basis. This provides an accurate way to estimate the value of a particular client base. Current norms include valuing a client base on a multiple of revenue or a multiple of net profit for the business.

A more accurate method for the NPV module 42 to calculate the NPV ratio involves the inclusion of a retention ratio. As a certain number of clients leave the firm over a period, the inclusion of a retention rate may be preferred where a periodic exit ratio is applied. For example, if may be determined that 5% of clients on the high service level leave over a certain period of time while 8% of client on the normal service level leave over the same period. Using appropriate statistical methods, the NPV of each client is reduced by the assigned retention ratio for that particular client. Applying this logic in a simple way, if client x has a NPV income stream of $3,000 and is expected to have a 90% chance of staying with the firm over this period, the NPV value would be adjusted to $3,000×90%=$2,700. The system may also record the satisfaction rate of a particular client with the service provided. Over time, this satisfaction rate measure may also be used to gauge potential exits and thereby adjust the NPV ratios accordingly.

The data integrity checker module 46 of the system 10 assigns a score or value for each data point captured on a client and stored in the database 22. These values are assigned according to the age of the data point and/or the importance of the data point. This provides a score for each client and allows the data integrity of the specific client to be determined. As databases are only as good as the data contained, this process is essential in maintaining the data integrity of the database. Once a data point reaches a set “use by date” (according to a set of rules), a lower score is then applied for that data point. In this way, it is possible to manage the internal validity of data on a client by client basis, with the onus to update values primarily resting with the contact person of the client.

This scoring system is shown by the web-page interface of FIG. 6, where column 70 is representative of the data point score.

It will be appreciated that the financial practice management system 10 may further be adapted in order to allow clients, whether potential or existing, to access the system to compare themselves to their “peers”, by inputting their residential code and age. These clients would then fill in their own need analysis, with the financial proxy module 38 determining shortfalls in their financial portfolio. The highlighted shortfalls would effectively become leads that could be referred to financial advisers that could tender for the business. Alternatively, clients could buy their own products on-line.

Given this information, the client would then post their needs on a web-page interface where advisers could bid for the business, or where the client could opt to invite pre-approved advisers to tender or negotiate on their business. Alternatively, the client may want to deal directly with financial service suppliers listed on the site. Feed-back forms and ratings could also be posted by these clients of the pre-approved financial advisers. In a way, this would provide a financial e-commerce interface, having the ability to estimate the value of the potential business.

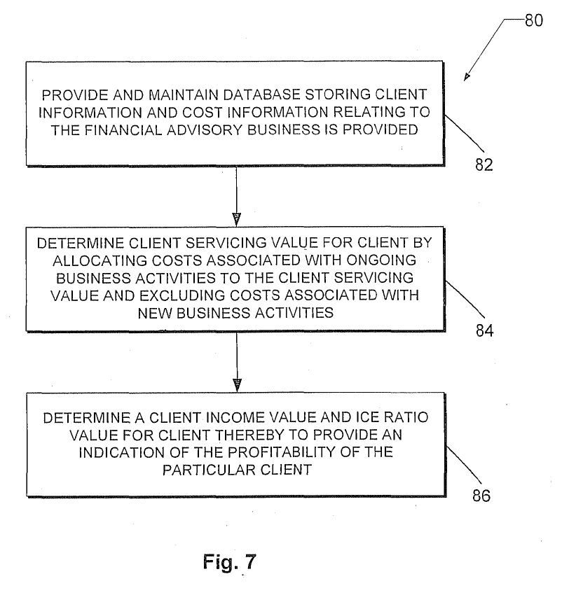

Turning to FIG. 7, a simplified flow diagram 80 is shown depicting a method of determining the profitability of a client of a financial advisory business in accordance with the present invention is shown. In one example embodiment of the invention, the method may be implemented by the system 10 of FIGS. 1 and 2.

As shown by step 82, a database 22 for storing client information and cost information relating to the financial advisory business is provided and maintained.

The cost allocation module 34 of FIG. 2 determines a client servicing value for a particular client by allocating costs associated with ongoing business activities to the client servicing value and excluding costs associated with new business activities (see step 84). As described in detail above, costs associated with ongoing business activities are allocated based on an ongoing business ratio which allocates the total of staff expenses not related to client activities and other non-staff expenses between ongoing business activities and new business activities.

In step 86, the individual client earnings (ICE) module 36 of FIG. 2 determines a client income value and determines an individual client earnings (ICE) ratio value for the particular client by dividing the difference between the client income value and the client servicing value with the client income value or client servicing value, thereby to provide an indication of the profitability of the particular client. The client income value is the income derived from the client's business with the financial advisory business from the database.

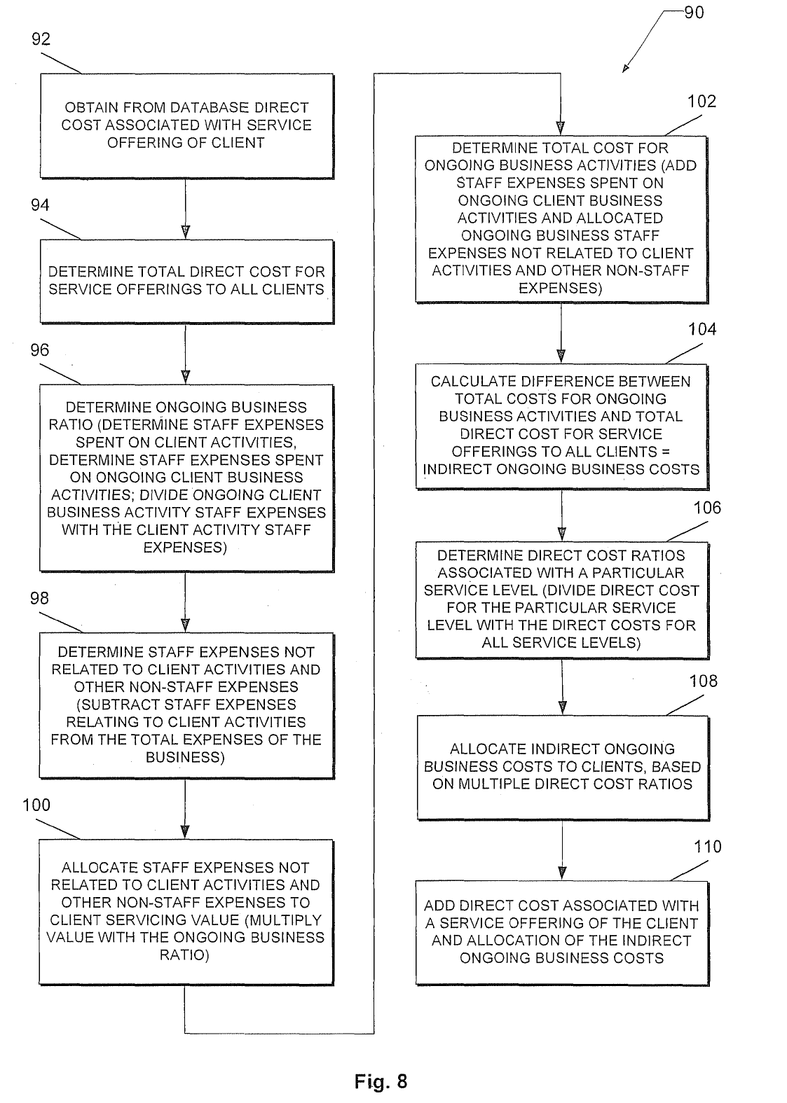

The method of determining a client servicing value (shown in step 84 of FIG. 7) is now described in more detail in accordance with the flow diagram 90 of FIG. 8. In one example embodiment, these steps are all performed by the cost allocation module 34 of FIG. 2.

At a first step 92, the cost allocation module 34 obtains from the database a direct cost associated with the service offering of the package a client is on. The total direct cost for service offerings to all clients are then determined through a simple multiplication process (step 94). Also see Table 2 above.

As shown by step 96, the cost allocation module 34 now determines the ongoing business ratio by determining a value for the staff expenses spent on client activities, determining a value for staff expenses spent on ongoing client business activities and then dividing the ongoing client business activity staff expenses with the client activity staff expenses. Also see Equation 2 above.

The total for staff expenses not related to client activities and other non-staff expenses are determined at step 98 by subtracting staff expenses relating to client activities from the total expenses of the business. Also see Equation 3 above.

As shown by step 100, the total of staff expenses not related to client activities and other non-staff expenses are allocated to the client servicing value by multiplying the value with the ongoing business ratio. Also see Table 5 above.

This is followed by the step of determining a total cost for ongoing business activities in which step the value for staff expenses spent on ongoing client business activities is added to the allocation of staff expenses which are not related to client activities and other non-staff expenses to ongoing business activities (step 102). Also see Table 5 above.

The difference between the total costs for ongoing business activities and the total direct cost for service offerings to all clients is determined (step 104). This difference is the value of the indirect ongoing business costs. Also see Table 6 above.

In step 106, direct cost ratios associated with a particular service level is determined by dividing the direct cost for the particular service level with the direct costs for all service levels. Also see Equation 4 and Table 7 above.

The indirect ongoing business costs are then allocated to clients based on multiple direct cost ratios (see step 108). Also see Table 8 above.

The final step (step 110) is the determination of the client servicing value of the client in which step the direct cost associated with a service offering of the client and an allocation of the indirect ongoing business costs are added together. Also see Table 8 above.

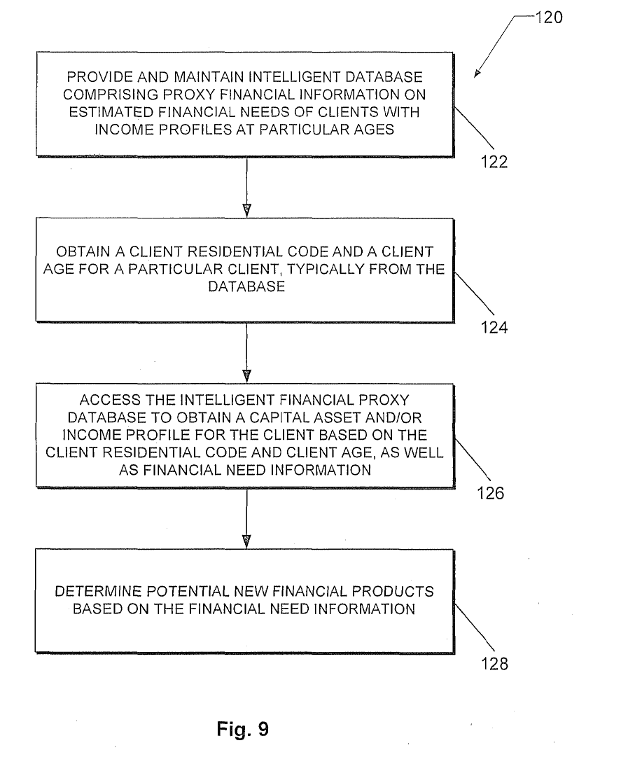

Turning now to FIG. 9, a simplified flow diagram 120 is shown of a method of managing a financial practice. Similar to the flow diagram of FIG. 7, in one example embodiment of the invention, the method may also be implemented by the system 10 of FIGS. 1 and 2.

The method comprises the steps of providing and maintaining an intelligent database comprising proxy financial information on estimated financial needs of clients associated with a particular income profile at a particular age (step 122).

In step 124, the financial proxy module 38 obtains a client residential code and a client age for a particular client, typically from the database 22. The financial proxy module 38 then accesses in step 126 the intelligent financial proxy database to obtain a capital asset and/or income profile for the client based on the client residential code and client age, as well as financial need information.

The potential new financial products based on the financial need information are determined by the financial proxy module 38 in step 128.

As discussed in more detail above, the income profiles of clients at a particular age are usually based on the estimated household income of a suburb, where the estimated household income per suburb is determined from an average house price in the suburb. This income profile may therefore be identified by a residential code of a new client.

1-45. (canceled)

46. A financial practice management system, comprising
an intelligent database comprising proxy financial information on estimated financial needs of clients associated with particular income profiles at particular ages; and
a financial proxy module configured to obtain a client residential code and a client age for a client, the financial proxy module configured to access the intelligent financial proxy database to obtain a capital asset and/or income profile for the client based on the client residential code and client age, as well as financial need information, thereby to determine potential new financial products for the client based on the financial need information.

47. A financial practice management system as claimed in claim 46 wherein the income profiles of clients at particular ages are associated with estimated household incomes of suburbs.

48. A financial practice management system as claimed in claim 47 wherein the estimated household income per suburb is associated with an average house price in the suburb.

49. A financial practice management system as claimed in claim 46 wherein the financial proxy module additionally determines a potential servicing revenue value from the potential new products for the client.

50. A financial practice management system as claimed in claim 49 wherein the financial proxy module is configured to obtain existing product information relating to products provided to the client by a financial institution from a client database and determines the potential new financial products by evaluating the financial need information in relation to the existing product information.

51. A financial practice management system as claimed in claim 49 wherein the potential servicing revenue value is commission and/or earned on the potential new financial products or ongoing servicing fees on the potential new financial products.

52. A financial practice management system as claimed in claim 46 wherein the financial proxy module is configured to create a list of financial products for the existing client.

53. A financial practice management system as claimed in claim 52 further comprising a profitable item module to rank the list of financial products according to the potential servicing revenue of each product, with the profitable item module allocating the products to a financial advisor of the system.

54. A financial practice management system as claimed in claim 46 further comprising a data integrity checker module which assigns a value to each data point captured and stored in the database.

55. A financial practice management system as claimed in claim 54 wherein the value assigned to each data point is according to the importance of the data point.

56. A financial practice management system as claimed in claim 54 wherein the value assigned to each data point is according to the age of the data point.

57. A financial practice management system as claimed in claim 54 wherein the data integrity checker module monitors each data point according to a set of rules, and lowers the score of the data point once the data point ages according to the set of rules.

58. A financial practice management system as claimed in claim 54 wherein the data integrity checker module generates an alert to be transmitted to a servicing adviser if the value of the data point reaches predetermined low level, thereby allowing the validity of data to be managed.

59. A method for managing a financial practice, the method comprising
providing an intelligent database comprising proxy financial information on estimated financial needs of clients associated with particular income profiles at particular ages;
obtaining a client residential code and a client age for a client;
accessing the intelligent financial proxy database to obtain a capital asset and/or income profile for the client based on the client residential code and client age, as well as financial need information; and
determining potential new financial products based on the financial need information.

60. A method as claimed in claim 59 wherein the income profiles of clients at particular ages are associated with estimated household incomes of suburbs.

61. A method as claimed in claim 60 wherein the estimated household income per suburb is associated with an average house price in the suburb.

62. A method as claimed in claim 59 including determining a potential servicing revenue value from the potential new products for the client.

63. A method as claimed in claim 59 further comprising obtaining existing product information relating to products provided to the client by a financial institution from a client database and determining the potential new financial products by evaluating the financial need information in relation to the existing product information.

64. A method as claimed in claim 59 wherein a list of financial products for the existing client is created.

65. A method as claimed in claim 64 further comprising ranking the list of financial products according to the potential servicing revenue of each product and allocating the products to a financial advisor.

66. A method as claimed in claim 59 further comprising assigning a value to each data point captured and stored in the database.

67. A method as claimed in claim 66 wherein the value assigned to each data point is according to the importance of the data point.

68. A method as claimed in claim 66 wherein the value assigned to each data point is according to the age of the data point.

69. A method as claimed in claim 66 wherein each data point is monitored according to a set of rules, and the score of the data point is lowered once the data point ages according to the set of rules.
